(19) United States
(12) Patent Application Publication
(10) Pub. No.: US 2007/0144649 A1
(43) Pub. Date: Jun. 28, 2007

(54) Overlay configuration for a tire

(76) Inventors: Patrick Joseph King, Hartville, OH (US); Keith Eric Grabo, Brecksville, OH (US); Leyla Kristen Renner, North Canton, OH (US); Keith Carl Trares, Akron, OH (US); Michael Lee Hiben, Fayetteville, NC (US); Melvin Lee Bostic, Fayetteville, NC (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/580,772

(22) Filed: Oct. 13, 2006

Related U.S. Application Data
(60) Provisional application No. 60/754,150, filed on Dec. 27, 2005.

(51) Int. Cl. B60C 9/00

(52) U.S. Cl. 152/531; 152/533

(57) ABSTRACT

A tire comprising a tread portion and a pair of sidewalls wherein the sidewalls are connected to the tread portion by shoulder regions, and wherein the tire further includes one or more strips of rubber affixed to the inner surface of a green tire. The strip may be annular and may be located near the toe of the bead. The strip is made from a rubber composition having a specific gravity greater than 2. The strip may be ground away as desired in order to balance the tire without the need for weights.

This application claims the benefit of, and incorporates by reference, U.S. Provisional Application No. 60/754,150 filed Dec. 27, 2005.

### FIELD OF THE INVENTION

The invention relates to radial tires, and more particularly to tires having overlays.

### BACKGROUND OF THE INVENTION

Radial tires are generally constructed with a breaker or belt interposed in the crown region of the carcass, such belt being composed of one or more layers or plies of tire cords which are generally inextensible and are made from such material as metallic wires, glass fibers, rayon, etc. In a mono-ply belt, the cords have a low bias angle of approximately 0°, i.e., they are oriented substantially parallel to the planes of the beads and to the median equatorial plane or crown center line of the tire. If the belt is of a multi-ply construction, similar but opposed low bias orientations of the cords or cables generally at angles ranging up to approximately 30° with respect to the median equatorial planes of the tire are employed in successive plies.

It is known in the art to provide an additional cover or cap ply of textile cords overlying the belt. The use of a cap ply endows a tire with additional travel comfort and safety, superior rolling resistance and in general improves the high speed characteristics of tires. The cap ply protects the metallic cords of the belt against the effects of humidity and reduces ply separation in the belt edges at elevated speeds.

One problem with manufacturing an overlay of cap plys is that it can be difficult to provide uniform coverage where the overlay covers the all the belt and the shoulder area. Thus an improved way of manufacturing a full width overlay is desired.

### BRIEF DESCRIPTION OF THE DRAWINGS

The invention will be described by way of example and with reference to the accompanying drawings in which:

FIG. 1 is a cross-sectional view of a tire of the present invention;

FIG. 2 is a close-up cross-sectional view of a portion of the shoulder assembly of the tire of FIG. 1; and

FIG. 3 is a cross-sectional view of the overlay layer of the tire only.

### DETAILED DESCRIPTION OF THE INVENTION

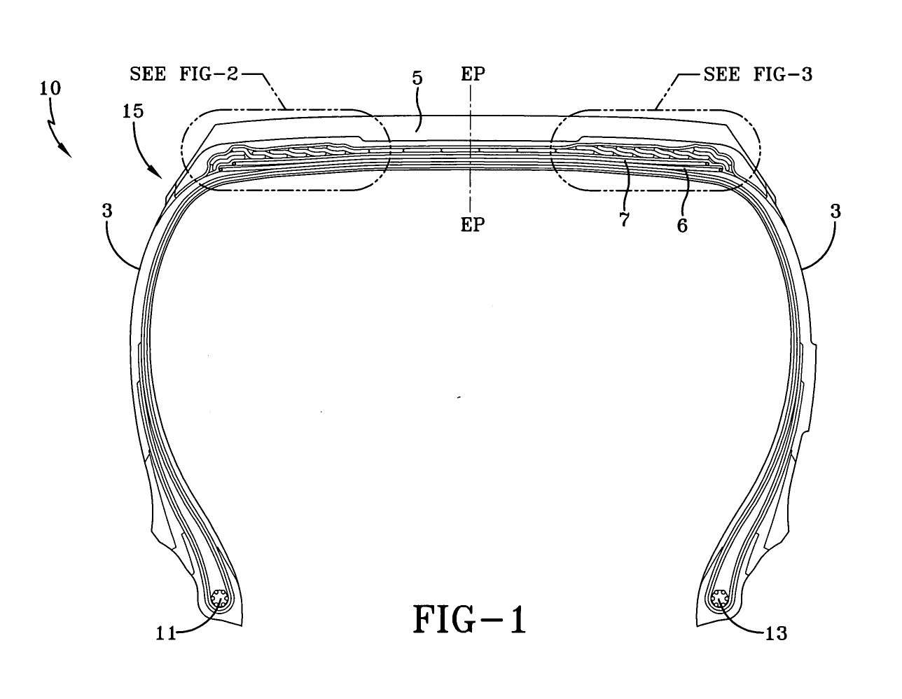

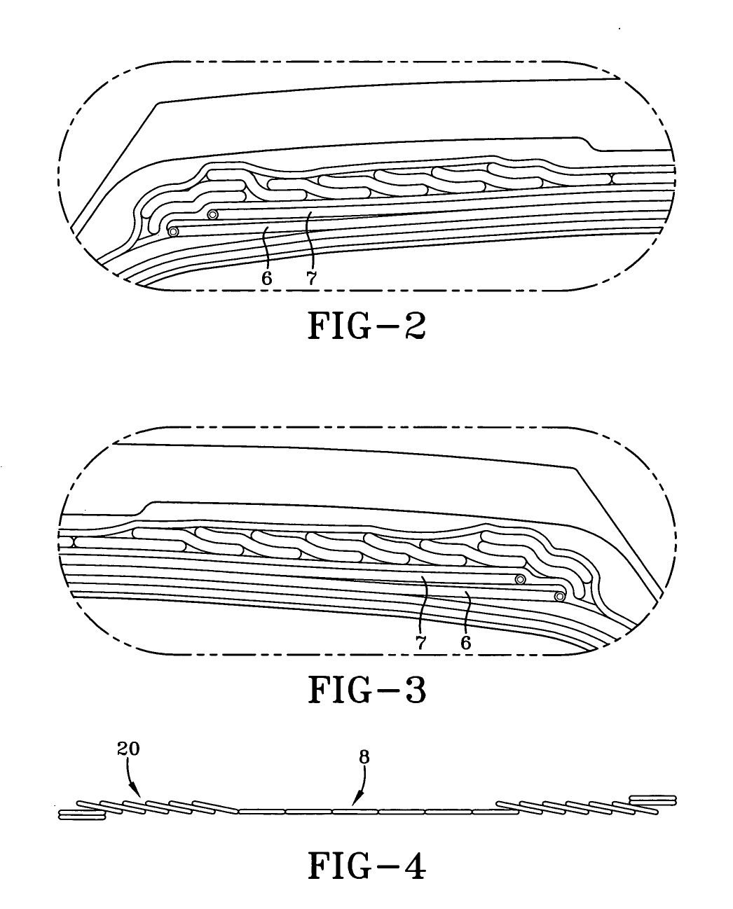

Referring now to FIG. 1, a radial tire 1 according to the present invention is shown. The tire 10 comprises a pair of annular beads 11 and 13 with a radial carcass ply 12 extending from one bead 11 to the other bead 13. The cords of the carcass ply are substantially parallel to each other and extend from bead to bead so as to make an angle with the mid-circumferential plane M-M of between 80 and 90 degrees. The cords of the carcass ply can be made of any suitable material such as rayon, steel, polyester, polyamide, or aromatic polyamide.

The crown area of the tire carcass 15 is reinforced by a belt assembly formed from one or more belt plies 6,7, each belt ply comprised of an elastomeric reinforced layer, typically reinforced by steel cords or cords made of any suitable material such as aromatic polyamide, glass fiber, PVA, carbon fiber or rayon.

The tire further includes a tread 5 overlying the crown region of the carcass 2 and adjoining the side walls 3 at their radially outwardmost region.

As shown in FIG. 1, the two belt plies 6 and 7 are of different widths in the direction of the tire axis, with the widest ply 7 typically having a width corresponding to the width of the tread 5. Alternatively, these plies 6 and 7 may both be made of equal width. The cord elements forming each of the plies 6 and 7 are oriented parallel to one another. The plies 6 and 7 are generally symmetrically oriented at respective equal but opposite bias angles to the median equatorial plane X-X′.

The tire further includes an overlay or cap ply 8 which is superimposed on the radially outwardmost belt ply 6 in direct contact with belt ply 6. The cap ply 8 is formed from a helically or spirally wound strip made from an elastomeric material reinforced by cords. The strip typically comprises a rubberized strip of two or more cords. Preferably the strip width is in the range of about 0.5 inches to about 1 inch. The strip coverage area extends past the ends of the widest belt, typically on the order of about 0-3 mm. On each shoulder area of the belt package, the strip is wound using a half pitch dwell. In other words, for every revolution of the tire building drum, the strip application head pitch is about 25 mm. In this particular shoulder area, the pitch is decreased to 12.5 mm or “half-pitch”. So in the shoulder area, the strips are applied on an angular stacked orientation wherein the strips overlap, as shown in FIG. 3. Preferably the strips overlap in such a manner that half width of a first strip mate with the half width of an adjacent strip. When laid up in such a manner, the strips essentially form a double row of strip at the shoulder area. At each end of the overlay, the strips are laid up in a double row.

Near the center or midplane portion of the tire, the strips are laid adjacent one another in a single row.

The orientation of each strip with respect to the equatorial plane of the tire is on the order of about 0 to about 5 degrees.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A pneumatic tire comprising a radial ply carcass, a tread disposed radially outward of the crown region of the carcass, and a crown reinforcing structure interposed between the tread portion and the crown region of the carcass, wherein the crown reinforcing structure comprises a belt assembly having one or more belt ply, wherein said one or more belt plies comprise reinforcement cords, and an overlay structure extending transversely over the belt plies, the overlay comprised of an elastomeric strip of two or more cords, the elastomeric strip making an angle of between 0 and 5 degrees with the equitorial plane of the tire, wherein the tire further comprises a shoulder area, and wherein the elastomeric strip is wound in the shoulder area in an overlapping manner and each strip overlaps the adjacent strip by the strip width/2.
